(19) United States
(12) Patent Application Publication
(10) Pub. No.: US 2007/0009751 A1
(43) Pub. Date: Jan. 11, 2007

(54) Polyamic acid resin composition modified with laminate nanometer silica sheet and polyimide prepared therefrom

(75) Inventors: Kuen-Yuan Hwang, Hsinchu Industrial District (TW); An-Pang Tu, Hsinchu Industrial District (TW); Sheng-Yen Wu, Hsinchu Industrial District (TW); Yu-Lin Huang, Hsinchu Industrial District (TW)

Correspondence Address: BACON & THOMAS, PLLC, 625 SLATERS LANE, FOURTH FLOOR, ALEXANDRIA, VA, 22314, US

(73) Assignee: Chang Chun Plastics Co., Ltd., Taipei City (TW)

(21) Appl. No.: 11/262,788

(22) Filed: Nov. 1, 2005

(30) Foreign Application Priority Data
Jul. 5, 2005 (TW) 094122758

(51) Int. Cl. B32B 27/00

(52) U.S. Cl. 428/473.5

(57) ABSTRACT

The present invention relates to a polyamic acid resin composition, which is characterized by containing nanolayer silica sheet and/or nanometer silica powder. The present invention also relates to a polyimide film prepared from the composition, the resultant film exhibits improved dimension stability, low water-absorbability, high transparency, and low Coefficient of Thermal Expansion (CTE) value and is suitable used in flexible print wiring board and wiring board for liquid crystal display (LCD).

This Non-provisional application claims priority under 35 U.S.C. §119(a) on Patent Application No(s). 094122758 filed in Taiwan, Republic of China on Jul. 5, 2005, the entire contents of which are thereby incorporated by reference.

### FIELD OF THE INVENTION

The present invention relates to a polyamic acid resin composition containing nanolayer silica sheet and/or nanometer silica powder and a polyimide film prepared from the polyamic acid resin composition.

### BACKGROUND OF THE INVENTION

With advancing of electronic technology, printed circuit boards on which electronic devices such as integrity circuit (IC), large scale integrity circuit (LSIC) are mounted are required increasingly. However, electronic machines such mobile cells are much expected to be miniaturization, lighting, multi-function, high reliability, and low cost.

To realize the miniaturization and lighting of the electronic machines, the method for mounting electronic devices usually uses film carrier tapes for mounting electronic devices, such as Tape Automatically Bonding (TAB) tape. Such film carrier tapes for mounting electronic devices are produced by adhering conductive metal such as copper foil on flexible insulating film such as polyimide film via resin adhesive, applying photosensitive resin on the conductive metal foil and exposing through a mask having a desired pattern, developing, and then etching to obtain desired circuit pattern.

To give the polyimide film dimension stability, it usually needs to add inorganic filler. However, to achieve the dimension stability required in the electronic industries, it should add a large amount of inorganic filler into the polyimide so that the transparency of the resultant polyimide film would reduce, which increases the difficulty for aligning and punching procedures in the subsequent processing. Additionally, the inorganic filler used usually natural mineral, such as micrometer order inorganic filler, for example, talc, mica or laminate clay, etc. Such natural mineral will affect the electric properties of the resultant polyimide film when used in electronic industries due to impurities contained therein.

Base on the above circumstances, the present inventors have conducted an investigation on the drawbacks of the current polyimide film and thus completed this invention.

### SUMMARY OF THE INVENTION

The present invention relates to a polyamic acid resin composition, which is characterized by containing nanolayer silica sheets and/or nanometer silica powder. The present invention also relates to a polyimide film prepared from the composition, the resultant film exhibits improved dimension stability, low water-absorbability, high transparency, and low Coefficient of Thermal Expansion (CTE) value and is suitable used in flexible print wiring board and wiring board for liquid crystal display (LCD).

More particularly, an object of the present invention provides a polyamic acid composition, which comprises laminate silica sheet and/or nanometer silica powder in an amount of from 0.3 to 15% by weight and polyamic acid resin in an amount of from 99.7 to 85% by weight, based on the total weight of the composition.

The polyamic acid used in the present invention is prepared from polymerization of di-anhydrides and diamines at various proportions, preferably from polymerization of aromatic di-anhydrides and aromatic diamines.

The present invention also provides a polyimide film, which is prepared by imidazing the polyamic acid resin composition according to the present invention.

According to the present invention, by adding only a little of filler, it can produce polyimide film having improved dimension stability, low water-absorbability, high transparency, and low Coefficient of Thermal Expansion (CTE) value, which is suitable used in flexible print wiring board and wiring board for liquid crystal display.

Since the polyimide film prepared in the present invention has high transparency and thus can resolve the problems of aligning occurred in conventional flexible circuit board.

### DETAILED DESCRIPTION OF THE INVENTION

The examples of the dianhydride used in the present invention to prepare the polyamic acid include, but not limit to, aromatic dianhydride, such as pyromellitic dianhydride (PMDA), 4,4′-biphthalic dianhydride (BPDA), benzophenone-3,3′,4,4′-tetracorboxylic acid dianhydride (BTDA), 4,4′-hexafluoroisopropylidene-diphthalic dianhydride (6FDA), 1-(trifluoromethyl)-2,3,5,6-benzenetetracarboxylic dianhydride (P3FDA), 1,4-di(trifluoromethyl)-2,3,5,6-benzene-tetra-carboxylic dianhydride (P6GDA), 1-(3′,4′-dicarboxyphenyl)-1,3,3-trimethyl-indan-5,6-dicarboxylic dianhydride, 1-(3′,4′-dicarboxyphenyl)-1,3,3-trimethyl-indan-6,7-dicarboxylic dianhydride, 1-(3′,4′-dicarboxy-phenyl)-3-methyl-indan-5,6-dicarboxylic dianhydride, 1-(3′,4′-dicarboxy-phenyl)-3-methyl-indan-6,7-dicarboxylic dianhydride, 2,3,9,10-perylene-tetracarboxylic dianhydride, 1,4,5,8-naphthalene-tetracarboxylic dianhydride, 2,6-dichloro-naphthalene-1,4,5,8-tetracarboxylic dianhydride, 2,7-dichloro-naphthalene-1,4,5,8-tetra-carboxylic dianhydride, 2,3,6,7-tetrachloro-naphthalene-2,4,5,8-tetra-carboxylic dianhydride, phenanthrenc-1,8,9,10-tetracarboxylic dianhydride, 3,3′,4′4′-benzophenone-tetracarboxylic dianhydride, 2,2′,3,3′-benzophenone-tetracarboxylic dianhydride, 3,3′,4′,4′-biphenyl-tetracarboxylic dianhydride, 2,2′,3,3′-biphenyl-tetracarboxylic dianhydride, 4,4′-isopropylidene-diphthalic dianhydride, 3,3′-isopropylidene-diphthalic dianhydride, 4,4′-oxy-diphthalic dianhydride, 4,4′-sulfonyl-diphthalic dianhydride, 3,3′-oxy-diphthalic dianhydride, 4,4′-methylene-diphthalic dianhydride, 4,4′-thio-diphthalic dianhydride, 4,4′-ethylidene-diphthalic dianhydride, 2,3,6,7-naphthalene-tetracarboxylic dianhydride, 1,2,4,5-naphthalene-tetracarboxylic dianhydride, 1,2,5,6-naphthalene-tetracarboxylic dianhydride, benzene-1,2,3,4-tetracarboxylic dianhydride, pyrazine-2,3,5,6-tetra-carboxylic dianhydride, and a combination thereof. Among them, pyromellitic dianhydride (PMDA), 4,4-biphthalic dianhydride (BPDA), benzophenone-3,3′,4,4′-tetracorboxylic acid dianhydride (BTDA), 4,4′-hexafluoroisopropylidene-diphthalic dianhydride (6FDA), 1-(trifluoromethyl)-2,3,5,6-benzenetetracarboxylic dianhydride (P3FDA), 1,4-bis(trifluoromethyl)-2,3,5,6-benzenetetracarboxylic dianhydride (P6GDA) are preferable.

The examples of the dimine used in the present invention to prepare the polyamic acid include, but not limit to, aromatic diamine, such as p-phenylenediamine (PDA), 4,4′-oxy-dianiline (ODA), 5-amino-1-(4′-amino phenyl)-1,3,3-trimethyl-indane; 6-amino-1-(4′-aminophenyl)-1,3,3-trimethyl-indane, 4,4′-methylene-bis(o-chloro-aniline), 3,3′-dichloro-dibenzidme, 3,3′-sulfonyl-dianiline, 4,4′-diamino-benzophenone, 1,5-diamino-naphthalene, bis(4-aminophenyl)diethylsilane, bis(4-aminophenyl)diphenylsilane, bis(4-aminophenyl)ethyl phosphine oxide, N-[bis(4-aminophenyl)]-N-methyl amine, N-(bis(4-aminophenyl))-N-phenyl amine, 4,4′-methylene-bis(2-methyl-aniline), 4,4′-methylene-bis-(2-methoxy-aniline), 5,5′-methylene-bis(2-aminophenol), 4,4′-methylene-bis(2-methyl-aniline), 4,4′-oxy-bis(2-methoxy-aniline), 4,4′-oxy-bis(2-chloro-aniline), 2,2′-bis-(4-aminophenol), 5,5′-oxy-bis(2-aminophenol), 4,4-thio-bis(2-methyl-aniline), 4,4′-thio-bis(2-methoxy-aniline), 4,4′-thio-bis(2-chloro-aniline), 4,4′-sulfonyl-bis(2-methyl-aniline), 4,4′-sulfonyl-bis(2-ethoxy-aniline), 4,4′-sulfonyl-bis(2-chloro-aniline), 5,5′-sulfonyl-bis(2-aminophenol), 3,3′-dimethyl-4,4′-diamino-benzophenone, 3,3′-dimethoxy-4,4′-diamino-benzophenone, 3,3′-dichloro-4,4′-diamino-benzophenone, 4,4′-diamino-biphenyl, m-phenylenediamine, p-phenylene-diamine, 4,4′-methylene-dianiline, 4,4′-thio-dianiline, 4,4′-sulfonyl-dianiline, 4,4′-isopropylidene-dianiline, 3,3′-dimethyl-dibenzidine, 3,3′-dimethoxy-dibenzidine, 3,3′-dicarboxy-dibenzidine, 2,4-tolyl-diamine, 2,5-tolyl-diamine, 2,6-tolyl-diamine, m-xylyl-diamine, 2,4-diamino-5-chloro-toluene, 2,4-diamino-6-chloro-toluene, and a combination thereof. Among them, p-phenylenediamine (PDA), 4,4′-oxy-dianiline (ODA) is preferable.

The reaction of the dianhydride and the diamine is preferably carried out in aprotic solvents. The solvents can be any kind of aprotic solvent as long as it is inert to the reaction. Examples of the solvent include, but not limit to, N,N-dimethylacetamide (DMAc), 1-methylpyrrolidone (NMP), N,N-dimethylformamide (DMF), tetrahydrofuran (THF), dioxane, methyl ethyl ketone (MEK), chloroform (CHCl₃), methylene chloride, and the like. Among them, 1-methylpyrrolidone (NMP) and N,N-dimethylacetamide (DMAc) are preferred.

The reaction of the dianhydride and the diamine is preferably carried out at a temperature of from ambient temperature to 90° C., preferably of from 30 to 75° C., and the equivalent ratio of the aromatic diamines to the aromatic dianhydrides is in a range of from 0.5 to 2, preferably in a range of from 0.75 to 1.25. The aromatic diamine and the aromatic dianhydrides each can be used in one kind or in a mixture of two or more kinds, depending on the final use of the polyimide film.

The nanolayer silica sheet and/or nanometer silica powder used in the polyamic acid resin composition of the present invention as fillers are a silica having a size of nanometer order, which can be in the form of layer or powder. If it is in the form of a sheet, it means that the thickness of the sheet is in the nanometer order, for example, in a range of from several nanometers to several hundreds nanometers, while its width is not limited, but its width is generally in a range of from several nanometers to several tens nanometers. If it is in the form of powder, it means that the average particle size of the powder is in the nanometer order. The term “average particle size of the powder” means the average of the longest diameter of the powder observed by a scanning electronic microscopy.

The nanolayer silica sheet and/or nanometer silica powder used in the polyamic acid resin composition of the present invention as fillers can further be supported on their surface with at least one metal element selected from the group of sodium, potassium, calcium, iron, magnesium, cobalt, chromium, nickel, zinc, magnesium, and aluminum, etc.

In the polyamic acid resin composition of the present invention, the amount of the polyamic acid prepared from dianhydrides and diamine and the silica sheet and/or powder, by taken the total weight of resin composition being 100% by weight, the amount of the fillers is from 0.3 to 15% by weight, preferably 0.5 to 10% by weight; the amount of the polyamic acid is from 85 to 99.7% by weight, preferably from 90 to 99.5% by weight.

The polyamic acid resin composition of the present invention can be prepared by respectively dissolving or dispersing the polyamic acid and the silica sheet and/or silica powder in a solvent to prepare each solution and then well mixing the two solutions. Alternatively, it can be prepared by directly mixing the polyamic acid and the silica sheet and/or silica powder to obtain a mixture, then dissolving and/or dispersing the mixture in a solvent, and finally well mixing the solution by a high speed mixer.

By adding the nanolayer silica sheet and/or nanometer silica powder as fillers in an amount of from 0.3 to 15% by weight, the polyimide film prepared from the polyamic acid resin composition of the present invention exhibits excellent dimensional stability, low water-absorbability, high transparency, and low Coefficient of Thermal Expansion (CTE) value and is suitable used in flexible print wiring board and wiring board for liquid crystal display.

The polyimide film according to the present invention is prepared from the polyamic acid resin composition mentioned above by coating on a suitable supporter in an appropriate thickness and then being subjected to imidazation, preferably via heat imidazation.

The imidazation used herein means a dehydrating reaction between the functional group —NH—CO— with the carboxylic functional group contained in the poly(amic acid) to form a cyclic group, it also refers cyclizing reaction. The imidazation is usually perfermed by heating, preferably by gradient increasing temperature. The temperature of the imidazation is preferably in a range of from 100 to 380° C. for a period of several minutes to several tens hours.

The supporter used for preparing the present polyimide film can be a polyimide film such as Kapton, Upliex (trademarks), and a metal foil such as a copper foil, an aluminum foil, a stainless steel foil, a nickel foil, etc. Among them, the copper foil is the most common used.

The present invention will be further illustrated by the following Examples. However, these Examples are not intended to limit the scope of the present invention.

### EXAMPLE 1

(a) Synthesis of Polyamic Acid

Into a four-neck round bottom flask equipped with a stirrer and N₂ inlet line was charged with p-phenylene diamine (PDA) 0.864 g (0.008 mole), 4,4′-oxydianiline (ODA) 6.4 g (0.032 mole), and N-methylpyrrolidine (NMP) 60 g to allow them dissolving slightly. Then nitrogen was purged and stirring was continued until content dissolving thoroughly while maintaining the reaction temperature at 25° C.

Then benzophenone-3,3′,4,4′-tetracorboxylic acid dianhydride (BTDA) 5.152 g (0.016 mole) and 25.0 g of NMP were added into the resultant mixture to perform reaction for 1 hour while keeping purging N₂. Subsequently, under keeping purging N₂, 4,4′-biphthalic dianhydride (BPDA) 2.352 g (0.008 mole) and 10.0 g NMP were added into the resultant solution and reacted further 1 hour. Finally, pyromellitic dianhydride (PMDA) 3.488 g (0.016 mole) and 20.0 g NMP were further added into the above solution and further reacted for 4 hours at a temperature of 25° C. under N₂ purging to obtain polyamic acid resin solution, which has a solid content of 14.6%. The instinct viscosity (VI) of the polyamic acid resin was measured by Ubbelhod Viscometer and found as 0.95 dl/g.

(b) Preparation of Dispersion of Nanometer Silica Sheet NaSL silica sheet (a silica sheet having a thickness of about 10 nanometers and length and width of about 1-2 micrometers, manufactured by Chang Chun Petrochemical Co., Ltd.) 2 g was added into 30 g NMP and dispersed by using high speed mixer in a rotation speed of 4000 rpm to obtain 2.5% silica sheet dispersion.

(c) Preparation of Polyamic Acid Resin Composition

The silica sheet dispersion obtained in the step (b) was added into the polyamic acid solution obtained in the step (a) and mixed thoroughly by using high speed mixer in a rotation speed of 4000 rpm to obtain polyamic acid resin composition.

(d) Preparation of Polyimide Film

The polyamic acid resin composition obtained in the step (c) was casting on a copper foil in an amount of obtaining a thickness after drying of 25 μm, placed in an oven at a temperature of 130° C. for 3 minutes and placed in an oven at a temperature of 170° C. for 6 minutes to remove most of solvent, and finally placed in an oven at a temperature of 350° C. for 1 hour to perform the imidazation of the polyamic acid to obtain polyimide film.

### EXAMPLES 2-6

Polyimide films of Examples 2-6 were prepared from the components listed in the following Table I according to the procedures similar to Example 1.

### Comparative Examples 1-2

Polyimide films of Comparative Examples 1-2 were prepared from the components listed in the following Table 1 according to the procedures similar to Example 1. In these Comparative Examples, talc or mica was used as fillers without using nanolayer silica sheet.

TABLE 1

| | | | | | | | Comp. | Comp. |
|---|---|---|---|---|---|---|---|---|
| | Ex. 1 | Ex. 2 | Ex. 3 | Ex. 4 | Ex. 5 | Ex. 6 | Ex. 1 | Ex. 2 |
| ODA(mole) | 0.032 | 0.032 | 0.032 | 0.032 | 0.032 | 0.036 | 0.032 | 0.032 |
| PDA(mole) | 0.008 | 0.008 | 0.008 | 0.008 | 0.008 | 0.004 | 0.008 | 0.008 |
| Total moles of | 0.04 | 0.04 | 0.04 | 0.04 | 0.04 | 0.04 | 0.04 | 0.04 |
| diamine | | | | | | | | |
| BTDA(mole) | 0.016 | 0.016 | 0.016 | 0.020 | 0.012 | 0.02 | 0.016 | 0.016 |
| BPDA(mole) | 0.008 | 0.008 | 0.008 | 0.008 | 0.008 | 0.008 | 0.008 | 0.008 |
| PMDA(mole) | 0.016 | 0.016 | 0.016 | 0.012 | 0.020 | 0.012 | 0.016 | 0.016 |
| Total moles of | 0.04 | 0.04 | 0.04 | 0.04 | 0.04 | 0.04 | 0.04 | 0.04 |
| dianhydrides | | | | | | | | |
| IV(dl/g) | 0.95 | 1.06 | 1.12 | 0.93 | 1.03 | 0.93 | 1.18 | 1.16 |
| NaSL %* | 2.5 | 5 | 10 | 5 | 5 | 5 | | |
| Talc %* | | | | | | | 10 | |
| Mica %* | | | | | | | | 10 |

Note:
*“%” is relative to the total weight of resin composition being 100% by weight.

The peeling strength test, dimensional stability test, water-absorption test, soldering heat resistance test, and transparency test of the polyimide films prepared from the Examples and Comparative Examples were measured as follows. The results were shown in Table 2.

1. Peeling Strength Test

This test was performed according to the method of IPC-TM-650 2.4.9. Firstly, a polyimide film was cut into specimens having a size of 2 cm×15 cm. Selected two specimens, each specimen was attached with two anti-etching tape and subjected to etching, water washing, drying, and then laminated with prepreg to obtain an laminate. The peeling strength of the laminate was measured by using Peeling-off tester and the results were reported in kgf/cm.

2. Dimensional Stability Test

This test was performed according to the method of IPC-TM-650 2.2.4. Firstly, a polyimide film supported on copper foil was cut into specimens having a size of 27 cm×29 cm. The specimen was punched four through holes having a diameter of 0.889 cm at its four comers each having a distance of 1.25 cm from the edge. Then the copper foil was etched and the distances between holes at mechanical direction (MD) and traverse direction (TD) were measured by dimension measuring apparatus. Subsequently, the specimen was placed and baked in an oven at a temperature of 150° C. for 30 minutes then stood at ambient temperature for 24 hours. The distances between holes at mechanical direction (MD) and traverse direction (TD) were measured again. The Dimensional stability was calculated from the measured MD distance and TD distance before and after backing.

The distance between two holes means the distance from the center of one hole to that of another hole. The first set and the second set holes in MD direction before baking were respectively referred to MD1_{before baking} and MD2_{before baking}, and those after baking were respectively referred to MD1_{after baking} and MD2_{after baking}. The first set and the second set holes in TD direction before baking were respectively referred to TD1_{before baking} and TD2_{before baking}, and those after baking were respectively referred to TD1_{after baking} and TD_{after baking}. The dimensional change percentage was calculated from the following formula:
Dimensional change % in MD={[(MD1_{after baking}−MD1_{before baking})/MD1_{before baking}]+[(MD2_{after baking}−MD2_{before baking})/MD2_{before baking}]}÷2×100
Dimensional change % in TD={[(TD1_{after baking}−TD1_{before baking})/TD1_{before baking}]+[(TD2_{after baking}−TD2_{before baking})/TD2_{before baking}]}÷2×100
3. Water-Absorption Test

This test was performed according to the method of IPC-TM-650 2.6.2. A polyimide film supported on copper foil was etched to remove copper foil to obtain the polyimide film and cut into specimens having a size of 10 cm². The specimen was placed in an oven at a temperature of 110° C. for 1 hour and then weighted as W1. Then the specimen was immersed in deionized water at room temperature for 24 hours, wiped dry with cloth, and weighted again as W2. Water-absorption was calculated from the data by following formula:
Water-absorption (%)=(W2−W1)/W1×100%
4. Soldering Heat Resistance Test

This test was performed according to the method of IPC-TM-650 2.4.13. A polyimide film supported on copper foil was cut into specimens having a size of 3 inches×7 inches. Selected two specimens, each specimen was coated with solder on the copper side and baked in an oven at a temperature of 135° C. Finally, the specimens were placed in a solder pot at a temperature of 288° C. in a manner that the copper side was faced down to check whether the polyimide film was foamed or layer-separated. If there was no foaming or layer-separating, the specimen was represented as “pass”.

5. Transparency Test

The transparency test was performed by using Ultraviolet (UV) spectrometer by scanning from wavelength of from 190 nm to 1100 nm. The transmittance percentage at 600 nm was presented as transparency.

TABLE 2

| | Ex. 1 | Ex. 2 | Ex. 3 | Ex. 4 | Ex. 5 | Ex. 6 | Comp. Ex. 1 | Comp. Ex. 2 |
|---|---|---|---|---|---|---|---|---|
| Peeling strength kgf/cm | 1.6 | 1.5 | 1.5 | 1.6 | 1.4 | 1.3 | 1.2 | 1.1 |
| MD dimension change % | −0.07 | −0.03 | −0.02 | −0.05 | −0.06 | −0.05 | −0.12 | −0.15 |
| TD dimension change % | −0.05 | −0.03 | −0.01 | −0.06 | −0.03 | −0.06 | −0.14 | −0.13 |
| Water absorption % | 1.5 | 1.6 | 1.4 | 1.7 | 1.5 | 1.6 | 1.9 | 2.2 |
| Solder heat resistance | Pass | Pass | Pass | Pass | Pass | Pass | Pass | Pass |
| (228□, 10 secs) | | | | | | | | |
| Transparency % | 43 | 37 | 32 | 36 | 38 | 37 | 29 | 25 |

From the Table 2, it shows that the polyimide added with nanometer silica sheet in Examples (the present invention) exhibit better peeling strength, dimensional stability, water-absorption, and transparency, as compared with Comparative Examples 1 and 2 in which conventional filler, i.e. talc and mica, were added. Furthermore, the polyimide film of the present invention also exhibited comparable heat resistance. The polyimide film prepared from the polyamic acid resin composition of the present invention exhibits excellent dimensional stability, low water-absorption, high transparency, and low Coefficient of Thermal Expansion (CTE) value and is suitable used in flexible print wiring board and wiring board for liquid crystal display.

While the present invention has been particularly shown and described with reference to exemplary embodiments thereof, it will be understood by those of ordinary skill in the art that various changes and modifications may be made therein without departing from the spirit and scope of the present invention as defined by the following claims.

What is claimed is:

1. A polyamic acid resin composition, which comprises, as fillers, nanolayer silica sheets and/or nanometer silica powder in an amount of from 0.3 to 15% by weight and polyamic acid resin in amount of from 99.7 to 85% by weight, based on the total weight of the composition.

2. The polyamic acid resin composition according to claim 1, wherein the nanolayer silica sheets and/or nanometer silica powder is contained in an amount of from 0.5 to 10% by weight.

3. The polyamic acid resin composition according to claim 1, wherein the polyamic acid resin is prepared from an aromatic dianhydride and an aromatic diamine.

4. The polyamic acid resin composition according to claim 3, wherein the aromatic diamine is selected from the group consisting of p-phenylene-diamine (PDA), 4,4′-oxy-dianiline (ODA), 5-amino-1-(4′-aminophenyl)-1,3,3-trimethyl-indane; 6-amino-1-(4′-aminophenyl)-1,3,3-trimethyl-indane, 4,4′-methylene-bis(o-chloro-aniline), 3,3′-dichloro-dibenzidme, 3,3′-sulfonyl-dianiline, 4,4′-diamino-benzophenone, 1,5-diamino-naphthalene, bis(4-aminophenyl)diethylsilane, bis(4-aminophenyl) diphenylsilane, bis(4-aminophenyl)ethyl phosphine oxide, N-[bis-(4-aminophenyl)]-N-methyl amine, N-(bis(4-aminophenyl))-N-phenyl amine, 4,4′-methylene-bis(2-methyl-aniline), 4,4′-methylene-bis-(2-methoxy-aniline), 5,5′-methylene-bis(2-aminophenol), 4,4′-methylene-bis(2-methyl-aniline), 4,4′-oxy-bis(2-methoxy-aniline), 4,4′-oxy-bis(2-chloro-aniline), 2,2′-bis-(4-aminophenol), 5,5′-oxy-bis(2-aminophenol), 4,4-thio-bis(2-methyl-aniline), 4,4′-thio-bis(2-methoxy-aniline), 4,4′-thio-bis(2-chloro-aniline), 4,4′-sulfonyl-bis(2-methyl-aniline), 4,4′-sulfonyl-bis(2-ethoxy-aniline), 4,4′-sulfonyl-bis(2-chloro-aniline), 5,5′-sulfonyl-bis(2-aminophenol), 3,3′-dimethyl-4,4′-diamino-benzophenone, 3,3′-dimethoxy-4,4′-diamino-benzophenone, 3,3′-dichloro-4,4′-diamino-benzophenone, 4,4′-diamino-biphenyl, m-phenylenediamine, p-phenylene-diamine, 4,4′-methylene-dianiline, 4,4′-thio-dianiline, 4,4′-sulfonyl-dianiline, 4,4′-isopropylidene-dianiline, 3,3′-dimethyl-dibenzidine, 3,3′-dimethoxy-dibenzidine, 3,3′-dicarboxy-dibenzidine, 2,4-tolyl-diamine, 2,5-tolyl-diamine, 2,6-tolyl-diamine, m-xylyl-diamine, 2,4-diamino-5-chloro-toluene, 2,4-diamino-6-chloro-toluene, and a combination thereof.

5. The polyamic acid resin composition according to claim 4, wherein the aromatic diamine is selected from the group consisting of p-phenylene-diamine (PDA), 4,4′-oxy-dianiline (ODA), and a combination thereof.

6. The polyamic acid resin composition according to claim 3, wherein the aromatic dianhydride is selected from the group consisting of pyromellitic dianhydride (PMDA), 4,4′-biphthalic dianhydride (BPDA), benzophenone-3,3′,4,4′-tetracorboxylic acid dianhydride (BTDA), 4,4′-hexafluoroisopropylidene-diphthalic dianhydride (6FDA), 1-(trifluoromethyl)-2,3,5,6-benzenetetracarboxylic dianhydride (P3FDA), 1,4-di(trifluoromethyl)-2,3,5,6-benzene-tetra-carboxylic dianhydride (P6GDA), 1-(3′,4′-dicarboxyphenyl)-1,3,3-trimethyl-indan-5,6-dicarboxylic dianhydride, 1-(3′,4′-dicarboxyphenyl)-1,3,3-trimethyl-indan-6,7-dicarboxylic dianhydride, 1-(3′,4′-dicarboxy-phenyl)-3-methyl-indan-5,6-dicarboxylic dianhydride, 1-(3′,4′-dicarboxy-phenyl)-3-methyl-indan-6,7-dicarboxylic dianhydride, 2,3,9,10-perylene-tetracarboxylic dianhydride, 1,4,5,8-naphthalene-tetracarboxylic dianhydride, 2,6-dichloro-naphthalene-1,4,5,8-tetracarboxylic dianhydride, 2,7-dichloro-naphthalene-1,4,5,8-tetra-carboxylic dianhydride, 2,3,6,7-tetrachloro-naphthalene-2,4,5,8-tetra-carboxylic dianhydride, phenanthrenc-1,8,9,10-tetracarboxylic dianhydride, 3,3′,4′4′-benzophenone-tetracarboxylic dianhydride, 2,2′,3,3′-benzophenone-tetracarboxylic dianhydride, 3,3′,4′,4′-biphenyl-tetracarboxylic dianhydride, 2,2′,3,3′-biphenyl-tetracarboxylic dianhydride, 4,4′-isopropylidene-diphthalic dianhydride, 3,3′-isopropylidene-diphthalic dianhydride, 4,4′-oxy-diphthalic dianhydride, 4,4′-sulfonyl-diphthalic dianhydride, 3,3′-oxy-diphthalic dianhydride, 4,4′-methylene-diphthalic dianhydride, 4,4′-thio-diphthalic dianhydride, 4,4′-ethylidene-diphthalic dianhydride, 2,3,6,7-naphthalene-tetracarboxylic dianhydride, 1,2,4,5-naphthalene-tetracarboxylic dianhydride, 1,2,5,6-naphthalene-tetracarboxylic dianhydride, benzene-1,2,3,4-tetracarboxylic dianhydride, pyrazine-2,3,5,6-tetra-carboxylic dianhydride, and a combination thereof.

7. The polyamic acid resin composition according to claim 6, wherein the aromatic dianhydride is selected from the group consisting of pyromellitic dianhydride (PMDA), 4,4-biphthalic dianhydride (BPDA), benzophenone-3,3′,4,4′-tetracorboxylic acid dianhydride (BTDA), 4,4′-hexafluoroisopropylidene-diphthalic dianhydride (6FDA), 1-(trifluoromethyl)-2,3,5,6-benzenetetracarboxylic dianhydride (P3FDA), 1,4-bis(trifluoromethyl)-2,3,5,6-benzenetetracarboxylic dianhydride (P6GDA), and a combination thereof.

8. A polyimide film, which is prepared by coating the polyamic acid resin composition according to claim 1 on a supporter and then imidazating.

9. The polyimide film according to claim 8, wherein the supporter is at least one selected from the group consisting of another polyimide film, copper foil, aluminum foil, stainless steel foil, and nickel foil.
